(19) United States
(12) Patent Application Publication
(10) Pub. No.: US 2013/0055962 A1
(43) Pub. Date: Mar. 7, 2013

(54) Dog Detox Kennel Apparatus and Method of Use

(71) Applicant: Marvin Scoggins, Diamond Bar, CA (US)

(72) Inventor: Marvin Scoggins, Diamond Bar, CA (US)

(21) Appl. No.: 13/604,346

(22) Filed: Sep. 5, 2012

Related U.S. Application Data
(60) Provisional application No. 61/573,447, filed on Sep. 6, 2011.

(51) Int. Cl. A01K 31/07

(52) U.S. Cl. 119/453

(57) ABSTRACT

A dog kennel is provided for safely performing an ionic detoxification bath. The kennel comprises a top and bottom container that are completely separable for easy of storage, and are secured together with seal proof latches and seams that prevent water leakage. The top container comprises a front and back door, a cutout window within the front door for extending the animal's head out of the kennel, ventilation holes along the side panels, and a water spout. The bottom container comprises a rectangular like tub for housing the electrode array immersed in a water bath, wherein the array is protected from making contact with the animal by being covered by a safety cage. Additionally, the bottom container comprises a salt spout to add salt and a thermometer to monitor the water temperature without opening the kennel doors.

### CROSS REFERENCE TO RELATED APPLICATIONS

The present application claims priority benefit under 35 U.S.C. §119(e) to U.S. Provisional Patent Application Ser. No. 61/573,447, filed Sep. 6, 2011. The present application incorporates the foregoing disclosures herein by reference.

### BACKGROUND OF THE INVENTION

1. Field of the Invention

This invention relates to animal kennels and containers, in particular the art of portable dog kennels.

2. Description of the Related Art

Ionic foot baths have become a popular holistic method of reducing toxins and heavy metals from a body (e.g. aluminum and arsenic) that are believed to interfere with normal biological functions. It is believed that removing these toxins and metals: relieves allergies, reduces blood pressure; reduces joint inflammation; boosts the immune system; reduces pain; etc. The procedure is popular with humans and their pets, notably dogs.

The process of ionic foot baths as disclosed in US Patent Application 20090069870, entitled “Ionic foot bath array” the entirety of which is incorporated herein by reference, comprises utilizing an electrical device connected to a container of salt water to generate an electrical current to produce negative ions from water molecules. The body then absorbs the ions through the feet (which are soaking in the water) and bind with positively charged toxins and minerals, such as harmful chemicals, heavy metals, parasites and etc. The ions become neutrally charged once they bind with the positively charged particles, and are pulled out through the feet via osmosis and gravity.

Although individuals may use a small tub to conduct the ionic bath, a pet needs a larger container and preferable one that can safely restrain the animal for the duration of the treatment. Animal kennels, specifically dog kennels, have been manufactured in various sizes, shapes, and material. They have been in existence for many years and have been reinvented to include, for example, grooming areas, height adjustments, air conditioners, and restraining apparatuses. Unfortunately, kennels do not have the ability to contain electrolyzed water baths while limiting an animal's movement to a stationery position as it undergoes an ionic detox session.

Therefore, there is a need for a portable dog kennel that allows for the containment of water in order to detox a dog and to prevent it from harming itself and others.

### SUMMARY OF THE INVENTION

The present invention comprises an ionic detox kennel for dogs, wherein said kennel possesses a generally rectangular top and a bottom container which are able to be completely detached from each other. The top container comprises the area housing the dog from the lower legs to the head. The bottom container comprises the area housing the water bath which the dog stands in during the detoxification procedure. The two containers may be secured together during the procedure via various connection means (e.g. locks), and then separated and stacked during, for example, travel and storage and releasing the dog from the kennel.

The top container of the kennel further comprises two rectangular side panels (herein left and right panel), a square front panel with a door, a square rear panel with a door, and a rectangular roof panel. There are also a plurality of ventilation holes to allow air circulation within the kennel. In a preferred embodiment, a row of holes runs horizontally along both side panels near the seam with the roof panel. The top kennel further comprises a water spout, such as on one side panel.

The front and rear panels of the top container also comprise a pivoting door. The doors are attached via pivoting hinges, and they are secured with latches that lock the dog within the kennel. The front panel further comprises a cutout, such as a circular hole, for the dog to comfortably stick his head out of the kennel during the detox procedure.

The bottom container comprises a rectangular shaped bathing tub of the same cross sectional area as the top container so that the two may be securely joined together without water spilling out of the kennel. The bottom container thus comprises a front and a rear panel, a right and left side panel, and a floor panel. A drainage hole resides in the center of floor wall for removing the water after the detox procedure is completed. The floor may further be angled at a slight slope to promote the drainage of the water towards the center of the floor.

The bottom container further comprises the detox electrode array, which is covered by a safety cage to protect it from the dog inadvertently stepping on it. And a salt spout resides on the front panel of the bottom container to allow the user to add salt to the water as part of the detox procedure without having to open the doors to the kennel. Additionally, a drilled thermometer hole is located on the bottom container's left side panel to monitor the temperature of the water during the procedure.

Both the bottom and top container comprise hard plastic material with seams that are molded together, or fabricated to be seamless, so as to prevent water leakage. The two containers are secured together with two pairs of catch and latch high impact strength plastic hinges located on the side panels. Sealing strips are also installed inside the bottom edge of the top container and/or the top edge of the bottom container to cover the seam created when joining the bottom and top containers, and thus prevent water spillage.

The principal object of the present invention is to provide an enclosed kennel which allows a dog to stand comfortably in water for an extended time while undergoing a detox session.

Another object of the present invention is to limit a dog's movement to a stationery position by providing a compact and fully enclosed animal kennel.

Still another object of the present invention is to allow the dog freedom of head movement by extending his head through a hole in the front door.

Yet, other objects of the invention are to facilitate cleaning, provide ventilation, and monitor the water temperature and increase its salt level.

Additionally, another object of the invention is to ensure the detox array reminds intact by shielding it with a spider cage.

Furthermore, another object of the invention is to promote the ease of entering and exiting the dog kennel.

These and other objects of the present invention will become readily apparent upon further review of the following specification and drawings.

### BRIEF DESCRIPTION OF THE DRAWINGS

The above and other features, aspects, and advantages of the present invention will become better understood with regard to the following description, appended claims, and accompanying drawings where:

FIG. 1 is an illustration of the right side view of the kennel.

FIG. 2 is an illustration of the left side view of the kennel with the rear door opened about 90 degrees.

FIG. 3 is an illustration of a front view of the kennel with the front door closed.

FIG. 4 is an illustration of a rear view of the kennel with the rear door closed.

FIG. 5 is an illustration of an overhead view of the bottom container showing the drainage hole and location of the cage protecting the ionic detox device.

FIG. 6 is a front perspective view of the kennel with the front door open.

FIG. 7 is a rear perspective view of the kennel with the rear door closed.

FIG. 8 is a front perspective view of the kennel's bottom and top container completely separated from each other.

FIG. 9 is a front perspective view of the kennel's bottom and top container completely separated from each other and the bottom container filled with salt water as per the ionic detoxification procedure.

FIG. 10 is a front perspective view of a dog within the kennel undergoing an ionic detoxification procedure as per the present invention.

Reference will now be made in detail to the present preferred embodiments of the present invention, examples of which are illustrated in the accompanying drawings. Wherever possible, the same reference numbers are used in the drawings and the description to refer to the same or the like parts.

### DETAILED DESCRIPTION

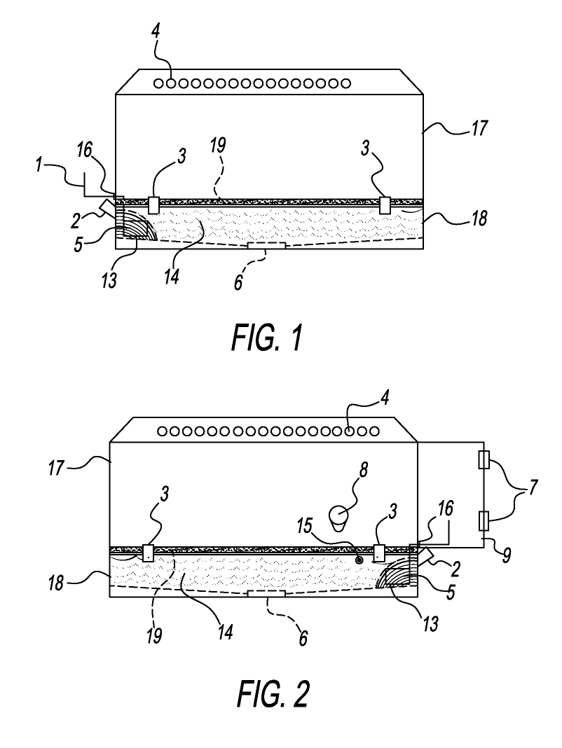

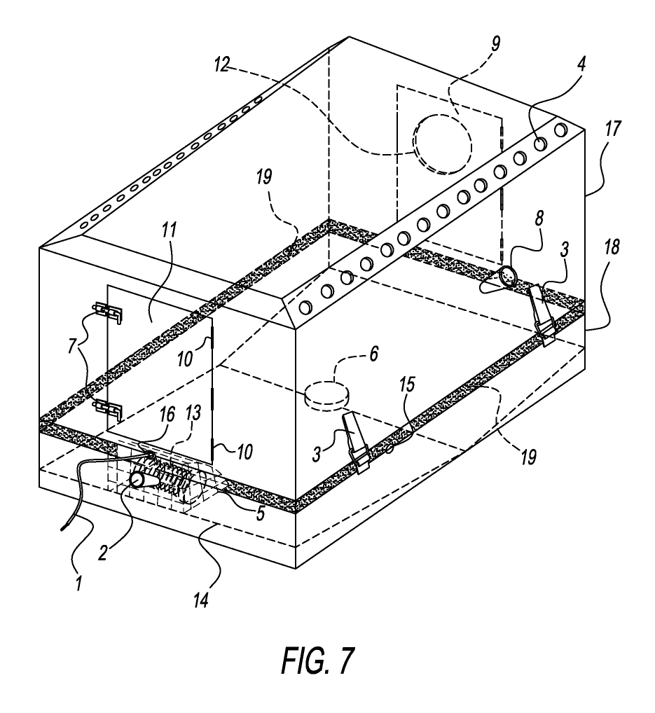

A preferred embodiment of the ionic detox kennel of the present invention is presented in FIGS. 1-10.

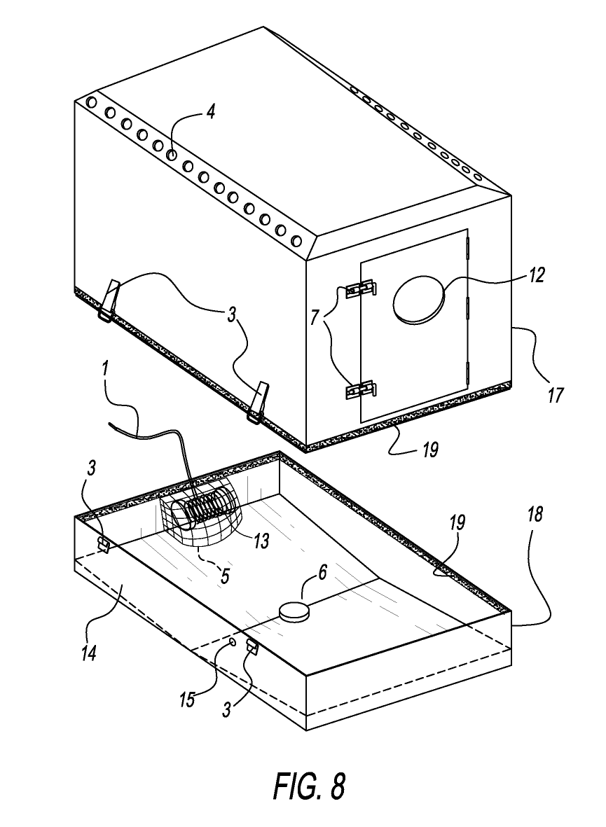

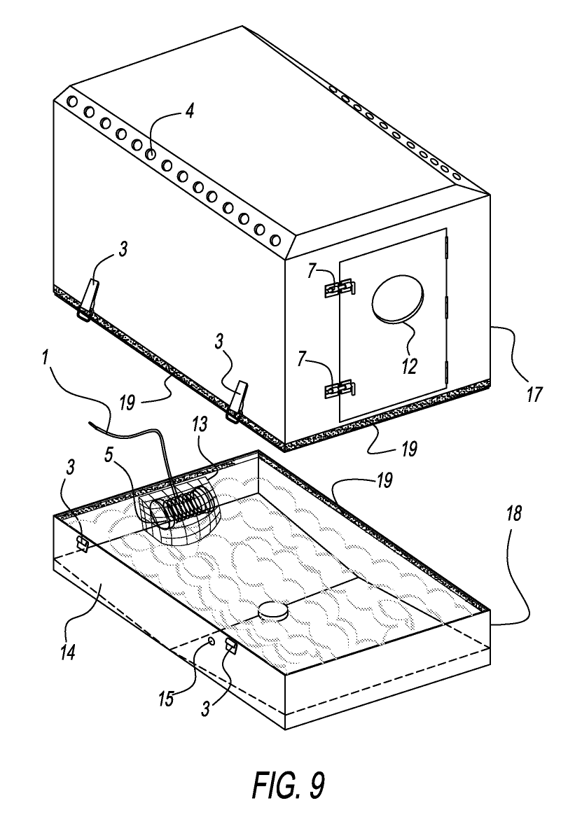

The kennel comprises a top container 17 and a bottom container 18 that may be completely separated (see FIGS. 8 and 9), or joined during use via a locking means 3 (see FIGS. 1-4, and 6-10). Types of locks 3 suitable for securing the two compartments together to prevent water spillage are well known in the art, and may comprise, for example, a latch, a case catch, or a draw bolt. Sealing strips 19 and grooved, fitted seams may also be used on the points of contact between the top container 17 and bottom container 18 to prevent water spillage. For example, as illustrated in FIGS. 8 and 9 the sealing strips 19 may be located on both the top container 17 and the bottom container 18 so as to contact or overlap each other.

The outer dimensions of the kennel will vary according to the size of the dog. For example, the kennel for an average size dog is about 32 inches long, 25 inches high, and 19 inches wide, wherein the bottom container is about 6 inches in height and the top container is about 19 inches in height.

The kennel is made of durable plastic material and weighs about 7 to 9 lbs. so that it may be easily transported by one individual carrying it unassisted. The kennel may be transported assembled (e.g. FIGS. 1-4, 6, 7 and 10) or disassembled (e.g. FIGS. 8 and 9).

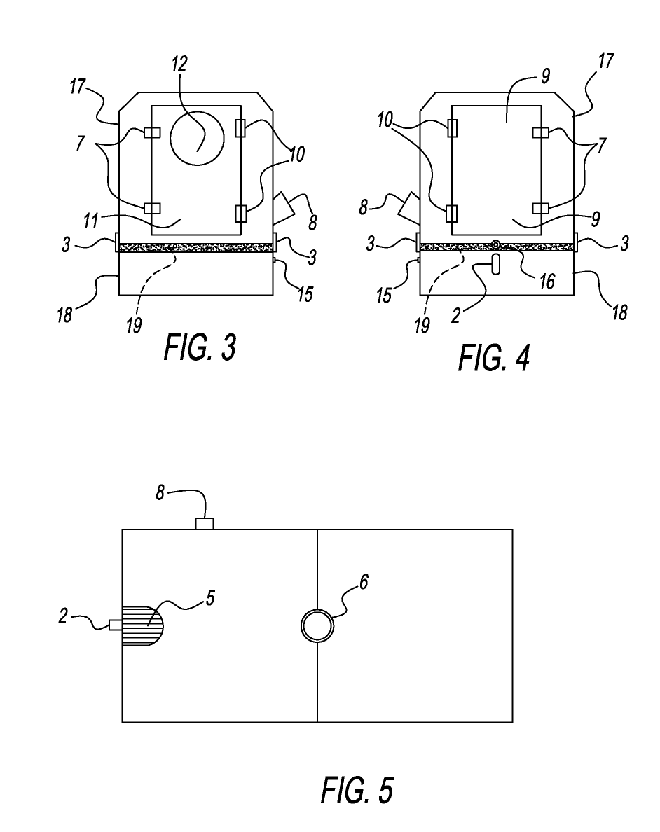

The top container comprises four panels (right, left, front, rear) with a front door 11, and a back door 9. The doors pivot on hinges 10, of which there are either two or three hinges (FIGS. 3, 4, 6, 7, and 10). The doors also comprise a locking means 7 to prevent the animal from escaping the kennel (FIGS. 2-4 and 6-10). In a preferred embodiment the locks 7 comprise deadbolt latches.

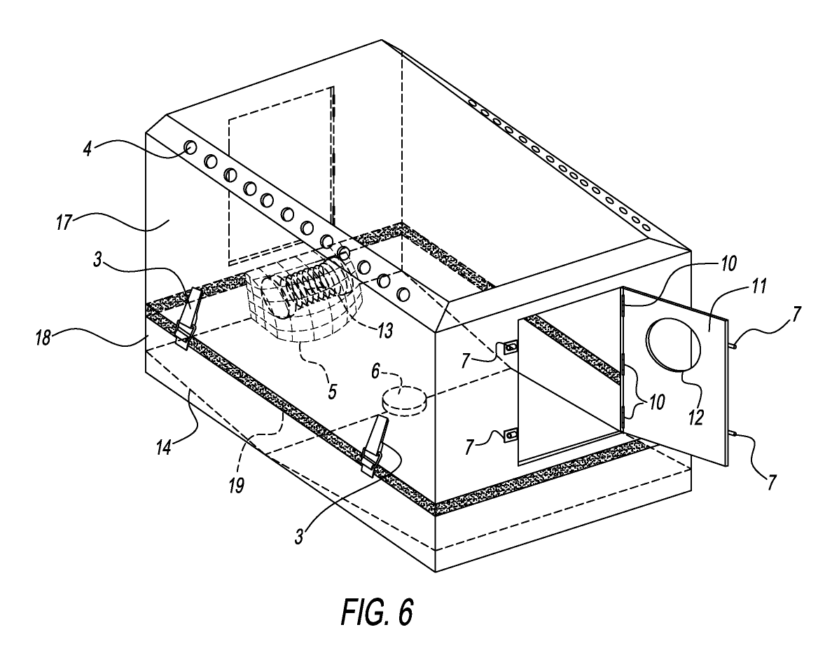

The bottom container comprises seams that are water proof, and thus do not permit water to inadvertently leak out between the side panels and the front or rear panel. Alternatively, the bottom container may comprise an internal surface that is synonymous with a seamless tub or basin to prevent water leakage. Additionally, the center of the floor of the bottom container comprises a drainage hole 6 with a plug. Once the animal has been removed from the kennel, the plug is removed and the water will drain onto the ground through the hole 6 (see FIGS. 1, 2, and 5-10). The floor 14 may further be sloped slightly inward so that the water will easily drain down toward the center whole 6 (see FIGS. 6-9, item 14).

Ionic Detoxification Control Devices with Electrode Arrays

As illustrated in FIG. 1, the present invention further comprises connecting an ionic detox machine (i.e. control device) to the kennel via electrical cord 1 running from the device residing a short distance outside of the kennel (not shown) through a hole 16 in the rear panel (see FIG. 4) to the electrode array 13. As an added safety measure, the electrode array 13 is covered with a safety shield 5, such as a plastic mesh cage (to prevent the animal from inadvertently making contact with the electrified array. The electrode array 13 is submerged in water contained in compartment 18 at a depth sufficient to cover the copper bar of the array 13. In a preferred embodiment the depth of compartment 18 is about 6 inches.

The present invention may utilize an existing ionic detox device, such as Cellspa Dual Ion Ionic Detox Foot Bath Spa MP3 manufactured by Aquacleanse, which generates a 70/30 mix of positive/negative polarity. The device is run according to the manufacturer's instructions; and, it would optimally operate at: 115 to 230 volts and 1.5 to 2.0 amperes wherein the treatment session would last about 15 minutes. Other components of the device comprise a 110v electrical plug to plug the machine in an outlet; a cuff for connectivity to ensure the machine is working; the array 13 to create the positive and negative ions; and an electric cord 1 to connect the device to the array 13.

An ionic detox bath requires the addition of salt to the water bath. Therefore, the kennel comprises a spout to pour salt into the bottom container without having to open the kennel doors. In a preferred embodiment, the salt spout 2 is located in the kennel's rear panel slightly above the electrode array 13 and cage 5 so as to increase the amount of ionized water produced by the array (see FIGS. 1, 2, 4, 5 and 7). It may be funneled shaped and angled slightly downward through the rear panel.

A water spout 8 is also used to add water to the bath without opening the kennel doors (see FIGS. 2-5, and 7). Like the salt spout, the water spout may be funneled shape and angled slightly downward through the right or left side panel.

Comfort of Animal

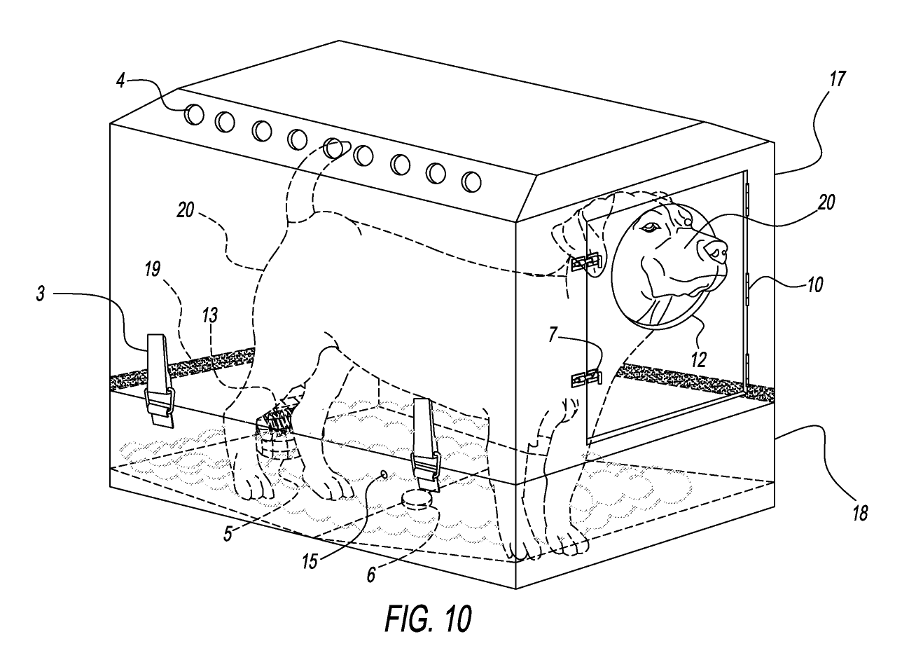

The kennel further comprises additional features to enhance the comfort of the animal during the ionic detoxification bath. As illustrated in FIG. 10, the kennel front door 11 may comprise a window cutout 12 that is of sufficient size and elevation to permit an animal 20 to stand with their head comfortably extending out of the kennel. The window also permits the animal to replenish himself by drinking from a heightened water container that is directly outside the front door.

The kennel also possesses ventilation holes lining the top container's side panels. In a preferred embodiment, the ventilation holes 4 are located on the seam between the right and left side panels and the roof of the top container (see FIGS. 1, 2, and 6-10).

Although the invention has been described with reference to specific embodiments thereof, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

What is claimed is:

1. A portable dog kennel for detoxification treatments, comprising:
a) a rectangular top container comprising a front, rear, roof, right side and left side panel of sufficient height to permit a medium sized dog to stand; and,
b) a rectangular bottom container comprising a front, rear, floor, right side and left side panel able to hold a water bath without leaking;
c) wherein said top and bottom container are joined with water tight seals.

2. The kennel of claim 1, wherein said floor panel further comprises a drainage hole with a plug for draining said bottom container when the plug is removed.

3. The kennel of claim 1, wherein said top container front panel further comprises a cutout hole of sufficient size for a dog's head to extend out of the kennel.

4. The kennel of claim 1, wherein said top container rear panel further comprises a rear door for accessing an ionic detoxification electrode array housed within said bottom container.

5. The kennel of claim 1, wherein said top container further comprises ventilation holes on said right and left side panels.

6. The kennel of claim 4, wherein said top container side panel further comprises a spout for pouring water into said bottom container; and said bottom container rear panel further comprises a spout for pouring salt onto said electrode array.

7. The kennel of claim 6, wherein said bottom container further comprises a safety cage covering said electrode array.

8. The kennel of claim 6, wherein said bottom container rear panel further comprises a hole for extending an electrical cord from said electrode array within said container to an ionic detoxification control device outside of said kennel.

9. The kennel of claim 1, wherein said top and bottom container are separable by releasing locking mechanisms joining said containers.

10. A portable dog kennel for ionic detoxification treatments, comprising:
a) a rectangular top container comprising a front, rear, roof, right side and left side panel of sufficient height to permit a medium sized dog to stand; and,
b) a rectangular bottom container comprising a front, rear, floor, right side and left side panel able to hold a water bath without leaking, and an ionic detoxification electrode array;
c) wherein said top and bottom container are separable by releasing locking mechanisms joining said containers.

11. The kennel of claim 10, wherein said floor panel further comprises a drainage hole with a plug for draining said bottom container when the plug is removed.

12. The kennel of claim 10, wherein said top container front panel further comprises a cutout hole of sufficient size for a dog's head to extend out of the kennel.

13. The kennel of claim 10, wherein said top container rear panel further comprises a rear door for accessing an ionic detoxification electrode array housed within said bottom container.

14. The kennel of claim 10, wherein said top container further comprises ventilation holes on said right and left side panels.

15. The kennel of claim 14, wherein said top container side panel further comprises a spout for pouring water into said bottom container; and said bottom container rear panel further comprises a spout for pouring salt onto said electrode array.

16. The kennel of claim 14, wherein said bottom container further comprises a safety cage covering said electrode array.

17. The kennel of claim 16, wherein said bottom container rear panel further comprises a hole for extending an electrical cord from said electrode array within said container to an ionic detoxification control device located outside of said kennel.

18. A method of administering a dog an ionic detoxification treatment comprising:
a) placing the dog within an ionic detoxification kennel comprising:
i) a rectangular top container comprising a front, rear, roof, right side and left side panel of sufficient height to permit a medium sized dog to stand; and,
ii) a rectangular bottom container comprising a front, rear, floor, right side and left side panel able to hold a water bath without leaking, and an ionic detoxification electrode array covered by a safety cage;
iii) an electrical cord extending from said electrode array to an ionic detoxification control device located outside of said kennel;
b) pouring water into said bottom container via a spout located on said top container side panel;
c) pouring salt into said bottom container via a spout located on said bottom container rear panel;
d) activating said ionic detoxification control device for about 15 minutes.

19. The method of claim 18, wherein said ionic detoxification control device is operated at within the ranges of about 115 to 230 volts and about 1.5 to 2.0 amperes.

20. The method of claim 18, wherein upon completion of said treatment, the control device is turned off, the dog is released from the kennel via removing the top container, and the bottom container is drained of the water.
